(19) United States
(12) Patent Application Publication
(10) Pub. No.: US 2021/0243773 A1
(43) Pub. Date: Aug. 5, 2021

(54) COMMUNICATION DEVICE

(71) Applicant: NTT DOCOMO, INC., Tokyo (JP)

(72) Inventors: Ryosuke Osawa, Chiyoda-ku, Tokyo (JP); Kazuaki Takeda, Chiyoda-ku, Tokyo (JP); Shinpei Yasukawa, Chiyoda-ku, Tokyo (JP)

(73) Assignee: NTT DOCOMO, INC., Tokyo (JP)

(21) Appl. No.: 17/052,665

(22) PCT Filed: May 21, 2018
(86) PCT No.: PCT/JP2018/019558

§ 371 Date: Nov. 3, 2020

(51) Int. Cl. H04W 72/10; H04W 56/00; H04W 72/12

(52) U.S. Cl. CPC H04W 72/10; H04W 72/1242; H04W 56/001

(57) ABSTRACT

A communication device includes a transmitter that transmits data; and a controller that causes, based on information indicating priority levels of respective radio resources of a plurality of radio resources and a priority level of the data, the transmitter to transmit the data using a radio resource provided with a priority level corresponding to the priority level of the data.

### TECHNICAL FIELD

The present invention relates to a communication device of a radio communication system.

### BACKGROUND ART

For LTE (long Term Evolution) and a successor system of LTE (e.g., LTE-A (LTE Advanced) and NR (New Radio, which is also referred to as 5G)), side link (which is also referred to as D2D (Device to Device)) technology has been studied such that communication devices, such as UEs, directly communicate with each other without intervention of a base station (Non-Patent Document 1).

In addition, studies have been conducted to achieve V2X (Vehicle to Everything), and specifications have been developed. Here, V2X is a part of ITS (Intelligent Transport Systems), and, as shown in FIG. 1, V2X is a collective term for V2V (Vehicle to Vehicle) that implies a communication mode performed between automobiles; V2I (Vehicle to Infrastructure) that implies a communication mode performed between an automobile and a road-side unit (RSU: Road-Side Unit) installed at a road side; V2N (Vehicle to Nomadic device) that implies a communication mode performed between an automobile and a mobile terminal of a driver; and V2P (Vehicle to Pedestrian) that implies a communication mode performed between an automobile and a mobile terminal of a pedestrian.

### PRIOR ART DOCUMENT

### Non-Patent Document

Non-Patent Document 1: 3GPP TS 38.213 V15.1.0 (2018-03)
Non-Patent Document 2: 3GPP TS 38.211 V15.1.0 (2018-03)
Non-Patent Document 3: 3GPP TSG-RAN WG1 Meeting #92bis, R1-1805744, Sanya, China, Apr. 16-Apr. 20, 2018

### SUMMARY OF THE INVENTION

### Problem to be Solved by the Invention

For V2X, various types of data with different requirements for communication (an error rate, latency, a communication rate, a communication type, etc.) are considered to be required to be transmitted and received. In this case, if, for various types of data, scheduling is performed differently, overhead for control signals may increase. Furthermore, by performing different scheduling for various types of data, specific data may be transmitted outside a bandwidth supported by a communication device, and the specific data may be unable to be received by the communication device.

There is a need for a technique that allows scheduling corresponding to a requirement for communication to be efficiently performed.

### Means for Solving the Problem

According to an aspect of the present invention, there is provided a communication device including a transmitter that transmits data; and a controller that causes, based on information indicating priority levels of respective radio resources of a plurality of radio resources and a priority level of the data, the transmitter to transmit the data using a radio resource provided with a priority level corresponding to the priority level of the data.

### Advantage of the Invention

According to disclosed technology, a technique is provided that allows scheduling corresponding to a requirement for communication to be efficiently performed.

### BRIEF DESCRIPTION OF DRAWINGS

FIG. 1 is a diagram illustrating V2X;

FIG. 2A is a diagram illustrating a sidelink;

FIG. 2B is a diagram illustrating a sidelink;

FIG. 3 is a diagram illustrating MAC PDU used for sidelink communication;

FIG. 4 is a diagram illustrating a format of a SL-SCH subheader;

FIG. 5 is a diagram illustrating an example of a channel structure used for a sidelink;

FIG. 6 is a diagram illustrating an example of a configuration of a radio communication system according to an embodiment;

FIG. 7 is a diagram illustrating a resource selection operation of a communication device;

FIG. 8 is a diagram illustrating an example of a bandwidth part operation;

FIG. 9A is a diagram illustrating an example in which PSCCH and PSSCH are time-multiplexed;

FIG. 9B is a diagram illustrating another example in which PSCCH and PSSCH are time-multiplexed;

FIG. 9C is a diagram illustrating an example in which PSCCH and PSSCH are frequency-multiplexed;

FIG. 9D is a diagram illustrating another example in which PSCCH and PSSCH are frequency-multiplexed;

FIG. 9E is a diagram illustrating another example in which PSCCH and PSSCH are frequency-multiplexed and time-multiplexed;

FIG. 9F is a diagram illustrating another example in which PSCCH and PSSCH are frequency-multiplexed and time-multiplexed;

FIG. 10 is a diagram illustrating an operation example of an embodiment;

FIG. 11 is a diagram illustrating an example of a functional configuration of a base station 10 according to an embodiment;

FIG. 12 is a diagram illustrating an example of a functional configuration of a communication device 20 according to an embodiment; and

FIG. 13 is a diagram illustrating an example of a hardware configuration of each of the base station 10 and the communication device 20 according to an embodiment.

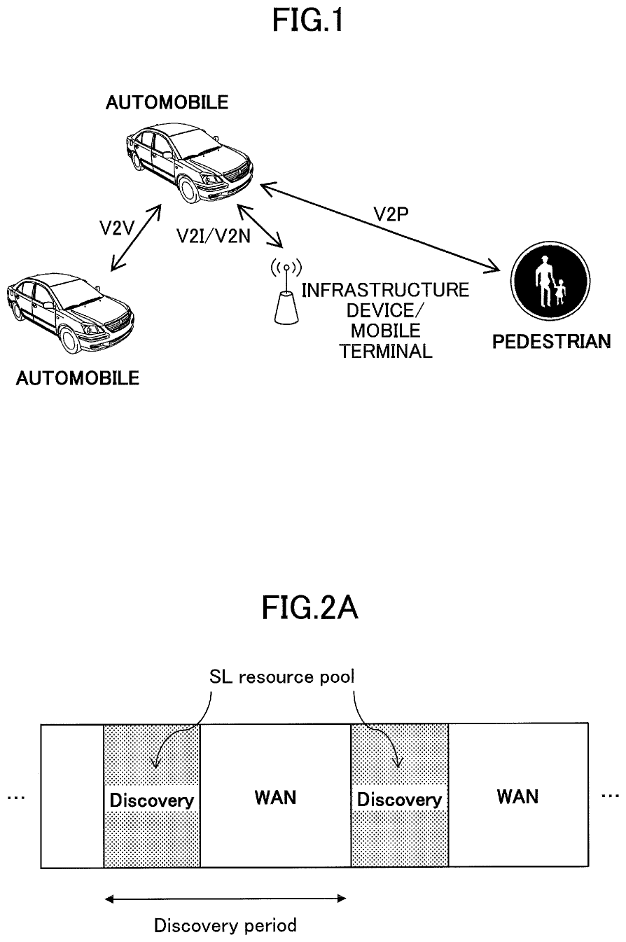

### EMBODIMENTS OF THE INVENTION

In the following embodiments of the present invention (the embodiments) are described by referring to the drawings. Note that the embodiments described below are merely examples, and embodiments to which the present invention is applied are not limited to the embodiments described below.

A direct communication scheme between communication devices according to the embodiments is assumed to be a sidelink (SL) of LTE or NR. However, the direct communication scheme is not limited to this scheme. Furthermore, a name “sidelink” is an example, and “sidelink” may be expressed as UL including a function of SL, without using the name of “sidelink.”

Additionally, UL and SL may be distinguished by a difference in one combination of or a plurality of combinations of time resources; frequency resources; time/frequency resources; reference signals that are referred to for determining pathloss in transmission power control; and a reference signal (PSSS/SSSS) used for synchronization.

For example, in UL, a reference signal of an antenna port X is used as a reference signal that is referred to for determining Pathloss in transmission power control, while, in SL (which includes UL used as SL), a reference signal of an antenna port Y is used as a reference signal which is referred to for determining Pathloss in transmission power control.

Furthermore, in the embodiments, an example is mainly assumed in which a communication device is installed in a vehicle. However, embodiments of the present invention are not limited to this example. For example, the communication device may be a terminal carried by a person, or the communication may be a device that is installed in a drone or an aircraft.

(Outline of Sidelink)

In the embodiment, since a sidelink is a basic technique, first, an outline of the sidelink is described as a basic example. An example of a technique described here is a technique specified in Rel. 14, etc., of 3GPP. This technique may be used in NR, or a technique other than this technique may be used in NR.

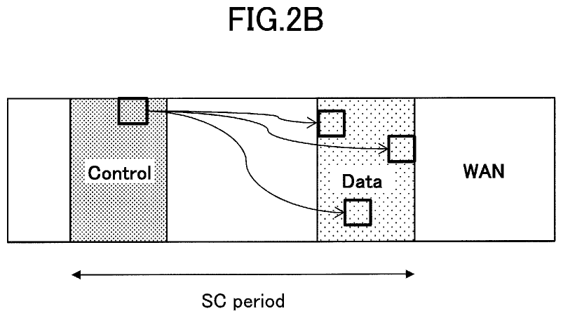

A sidelink is broadly divided into “discovery” and “communication.” As for “discovery,” as illustrated in FIG. 2A, a resource pool for a discovery message is reserved for each discovery period, and a communication device (which may be referred to as a UE) transmits a discovery message (discovery signal) within the resource pool. More specifically, there are Type 1 and Type 2b. In Type 1, a communication device autonomously selects a transmission resource from a resource pool. In Type 2, semi-static resources are allocated by a higher layer signaling (e.g., an RRC signal).

As for “communication,” as illustrated in FIG. 2B, a resource pool for SCI (Sidelink Control Information) transmission/data transmission is periodically reserved. A transmitting communication device reports, to a receiving side, a data transmission resource (PSCCH resource pool), etc., by SCI with a resource selected from a Control resource pool (PSCCH resource pool), and the transmitting communication device transmits data with data transmission resource. More specifically, there are mode 1 and mode 2 for “communication.” In mode 1, a resource is dynamically allocated by (E)PDCCH ((Enhanced) Physical Downlink Control Channel) transmitted from a base station to a communication device. In mode 2, a communication device autonomously selects a transmission resource from a resource pool. As for a resource pool, a predefined resource pool is used, such as a resource pool reported by SIB.

Furthermore, in Rel-14, in addition to mode 1 and mode 2, there are mode 3 and mode 4. In Rel-14, SCI and data can be simultaneously transmitted (within 1 subframe) with resource blocks adjacent each other in a frequency direction. Note that SCI may be referred to as SA (scheduling assignment).

A channel used for “discovery” is referred to as PSDCH (Physical Sidelink Discovery Channel), a channel for transmitting control information, such as SCI, in “communication” is referred to as PSCCH (Physical Sidelink Control Channel), and a channel for transmitting data is referred to as PSSCH (Physical Sidelink Shared Channel). Each of PSCCH and PSSCH has a structure based on PUSCH, and the structure is such that DMRS (Demodulation Reference Signal, demodulation reference signal) is inserted.

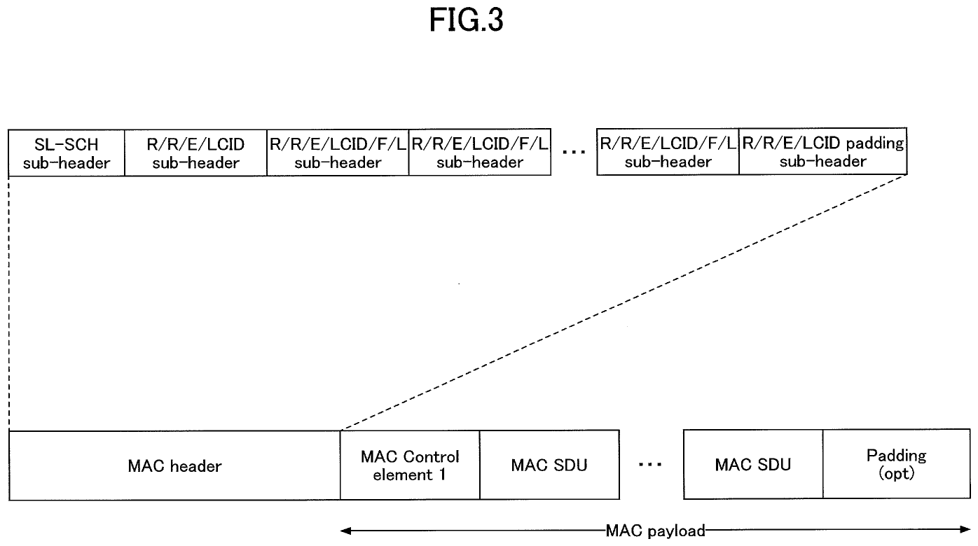

As illustrated in FIG. 3, a MAC (Medium Access Control) PDU (Protocol Data Unit) used for a sidelink is formed of, at least, a MAC header, a MAC Control element, a MAC SDU (Service Data Unit), and Padding. MAC PDU may include any other information. A MAC header is formed of one SL-SCH (Sidelink Shared Channel) subheader and one or more MAC PDU subheaders.

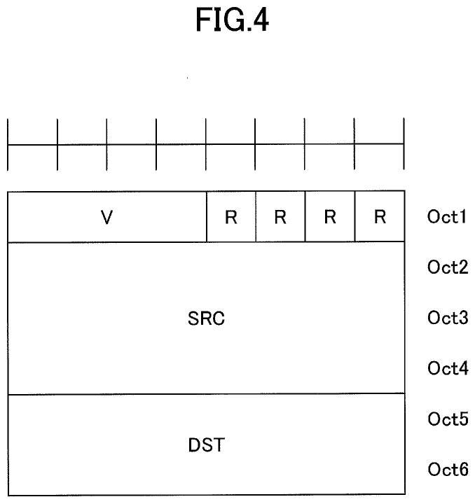

As illustrated in FIG. 4, an SL-SCH subheader is formed of a MAC PDU format version (V); transmission source information (SRC); transmission destination information (DST); a Reserved bit (R); etc. The V is allocated at a start of the SL-SCH subheader and represents a MAC PDU format version used by a communication device. In the transmission source information, information about a transmission source is configured. In the transmission source information, an identifier related to a ProSe UE ID may be configured. In the transmission destination information, information related to a transmission destination is configured. In the transmission destination information, information related to a ProSe Layer-2 Group ID of the transmission destination may be configured.

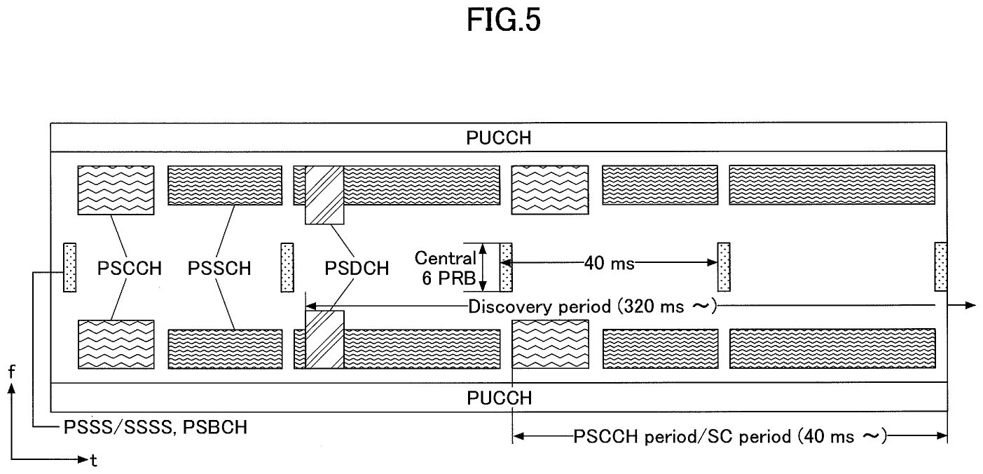

FIG. 5 shows an example of a channel structure of a sidelink. As illustrated in FIG. 5, a PSCCH resource pool and a PSSCH resource pool are allocated, which are used for “communication.” Additionally, a PSDCH resource pool used for “discovery” is allocated with a period that is longer than a period of a channel of “communication.”

Furthermore, as a synchronization signal for a sidelink, PSSS (Primary Sidelink Synchronization signal) and SSSS (Secondary Sidelink Synchronization signal) are used. Additionally, PSBCH (Physical Sidelink Broadcast Channel) is used for transmitting broadcast information (broadcast information), such as a system band of a sidelink, a frame number, resource configuration information, and so forth for an out of coverage operation. For example, PSSS/SSSS and PSBCH are transmitted with a single subframe. PSSS/SSSS may be referred to as SLSS.

Note that V2X assumed for the embodiments is a scheme related to “communication.” However, in the embodiments, there may be no distinction between “communication” and “discovery.” Additionally, the technique according to the embodiments may be applied to “discovery.”

(System Configuration)

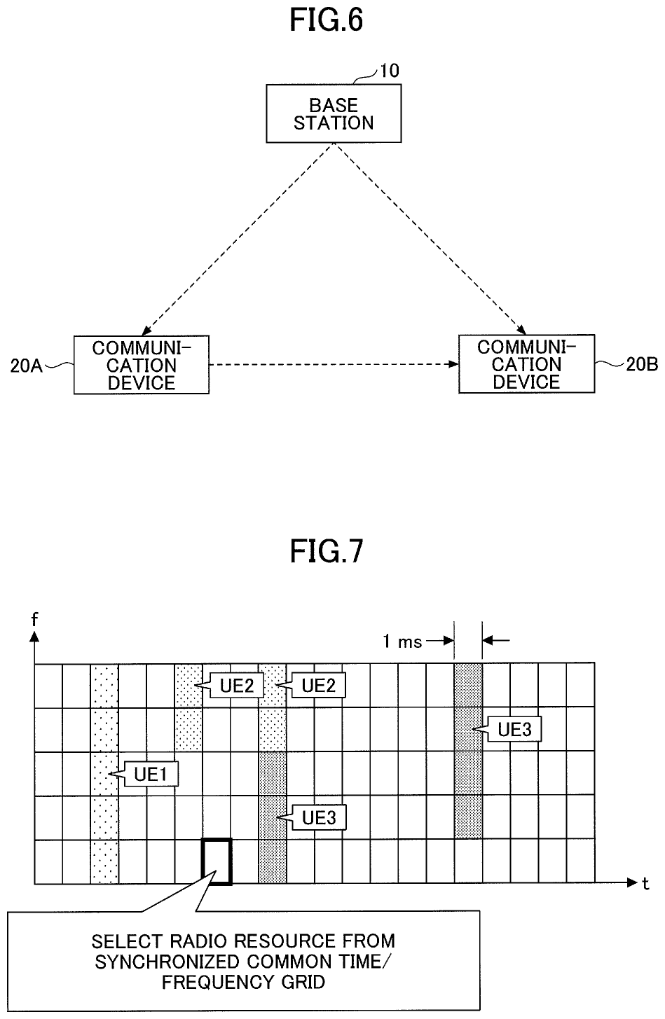

FIG. 6 is a diagram illustrating an example of a configuration of a radio communication system according to an embodiment. As illustrated in FIG. 6, the radio communication system according to the embodiment includes a base station 10; a communication device 20A; and a communication device 20B. Note that, though there can actually be a large number of communication devices, the communication device 20A and the communication device 20B are illustrated in FIG. 6, as an example.

In FIG. 6, the communication device 20A is intended to be a transmission side and the communication device 20B is intended to be a reception side. However, each of the communication device 20A and the communication device 20B includes a transmission function and a reception function. In the following, if the communication devices 20A, 20B, etc., are not particularly distinguished, the communication devices are simply denoted as “communication device 20” or “communication device.” In FIG. 6, a case is illustrated, as an example, in which both the communication device 20A and the communication device 20B are within coverage. However, the operation according to the embodiments can be applied to any one of a case in which all the communication devices 20 are located within coverage; a case in which a part of the communication devices 20 is located within coverage and the other communication devices 20 are located outside the coverage; and a case in which all the communication devices 20 are located outside the coverage.

In the embodiments, the communication device 20 is, for example, a device installed in a vehicle, such as an automobile, and the communication device 20 is provided with a function for cellular communication, as a UE in LTE or NR, and a sidelink function. Additionally, the communication device 20 includes a function for obtaining report information (a location, event information, etc.), such as a GPS device, a camera, various types of sensors, etc. The communication device 20 may be a generic mobile terminal (e.g., a smartphone). The communication device 20 may be an RSU. The RSU may be a UE-type RSU provided with a UE function, or a gNB-type RSU (which may be referred to as a gNB-type UE) provided with a function of a base station.

Note that the communication device 20 is not required to be a device with a single enclosure. For example, if various types of sensors are distributed to be installed in a vehicle, the device including the various types of sensors is the communication device 20. Alternatively, the communication device 20 may be provided with a function for transmitting data to and receiving data from the various types of sensors, without including various types of sensors.

Basically, details of a transmission process of a sidelink by the communication device 20 are the same as details of UL transmission process of LTE or NR. For example, the communication device 20 scrambles and modulates a codeword of transmission data to generate complex-valued symbols, and the communication device 20 maps the complex-valued symbols (transmission signal) onto one or two layers and performs precoding. Then, the precoded complex-valued symbols are mapped onto resource elements, and transmission signals (e.g., complex-valued time-domain SC-FDMA signals) are generated and transmitted from respective antenna ports.

The base station 10 is provided with a function for cellular communication, as the base station 10 in LTE or NR, and a function for enabling communication (e.g., configuring a resource pool, allocating a resource, etc.) by the communication device 20 according to the embodiments.

Additionally, the base station 10 may be an RSU (a gNB-type RSU).

In the radio communication system according to the embodiments, a signal waveform used by the communication device 20 in SL or UL may be that of OFDM, that of SC-FDMA, or any other waveform. Furthermore, in the radio communication system according to the embodiments, as an example, a frame is formed that is formed of a plurality of subframes (e.g., 10 subframes) in a time direction and that is formed of a plurality of subcarriers in a frequency direction. One subframe is an example of one transmission timer interval (TTI: Transmission Time Interval). A time length other than a subframe may be used as a transmission time interval.

Furthermore, a slot number per one subframe may be determined according to subcarrier spacing. The symbol number per one slot may be 14 symbols.

In the embodiments, the communication device 20 may be in any one of mode 1 that is a mode in which a resource is dynamically allocated by (E)PDCCH ((Enhanced) Physical Downlink Control Channel) transmitted from a base station to the communication device; mode 2 that is a mode in which the communication device autonomously selects a transmission resource from a resource pool; a mode in which a resource for SL signal transmission is autonomously selected (which is referred to as mode 4, hereinafter); and a mode in which a resource for SL signal transmission is allocated from the base station 10 (which is referred to as mode 3, hereinafter). For example, a mode is configured for the communication device 20 by the base station 10.

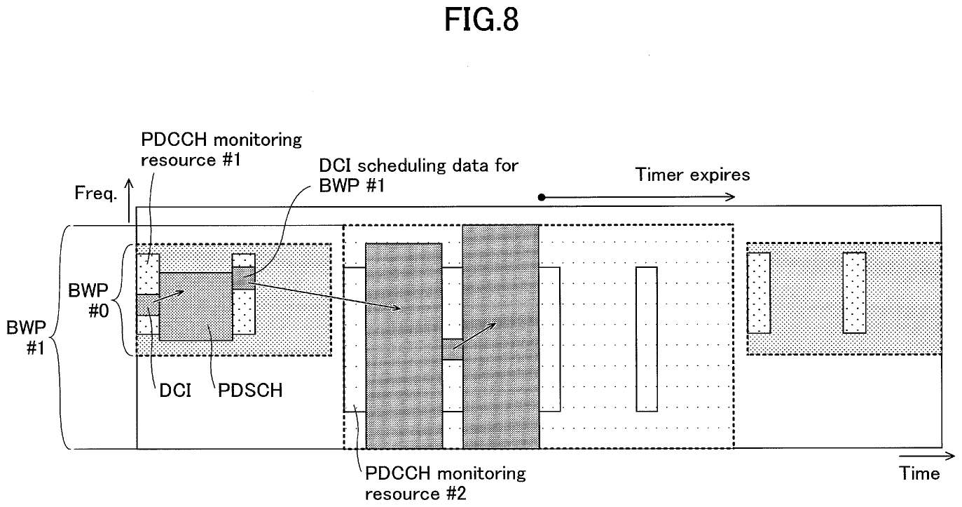

As illustrated in FIG. 7, a communication device in mode 4 (which is shown as UE in FIG. 7) selects a radio resource from synchronized common time/frequency grids. For example, the communication device 20 performs background sensing to identify, as candidate resources, resources with favorable sensing results that are not reserved by another communication device, and the communication device 20 selects a resource to be used for transmission from the candidate resources.

In 3GPP Release 15 NR, a bandwidth part operation is specified in which a terminal dynamically switches a bandwidth for transmission and reception (Non-Patent Document 1). A bandwidth part denotes a subset of adjacent common resource blocks.

In a downlink, up to four bandwidth parts can be configured for user equipment (UE). In this case, a single downlink bandwidth part is effective in each time. A UE receives PDSCH (Physical Downlink Shared Channel), PDCCH, or CSI-RS (Channel State Information Reference Signal) within an effective bandwidth part. Namely, PDSCH, PDCCH, and CSI-RS are assumed not to be transmitted outside the bandwidth part (Non-Patent Document 2).

Additionally, in an uplink, up to four bandwidth parts can be configured for a UE. In this case, a single uplink bandwidth part is effective in each time. If a supplementary uplink (Supplementary uplink, SUL) is configured for a UE, up to four bandwidth parts can be additionally configured for the UE in the supplementary uplink. In this case, a single additional uplink bandwidth part is effective in each time. A UE does not transmit PUSCH or PUCCH outside an effective bandwidth part. Namely, a UE transmits PUSCH or PUCCH within an effective bandwidth part.

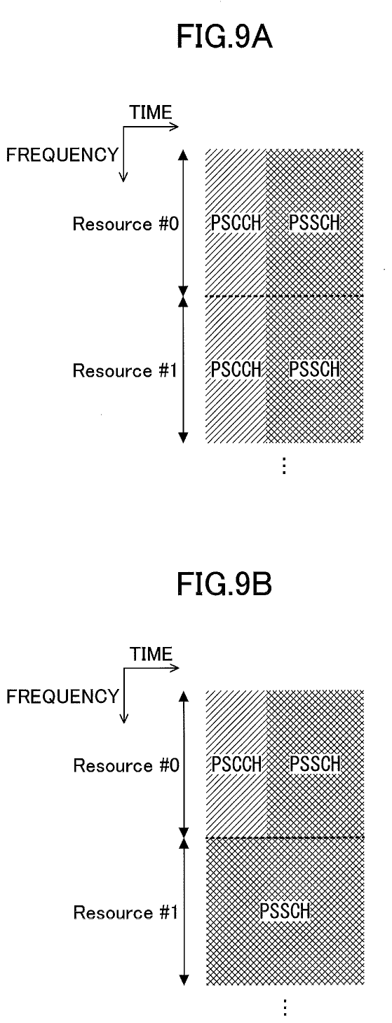

FIG. 8 shows an example of a bandwidth part operation. For example, upon initial-access (initial-access), a UE has a knowledge of a minimum bandwidth (BW) required for the initial-access, and the UE communicates with a base station in the minimum bandwidth. For example, in the example of FIG. 8, the UE communicates with the base station through the bandwidth part (BWP) #0.

Subsequently, the UE monitors PDCCH and receives downlink control information (DCI) transmitted from the base station through PDCCH. At this time, the DCI includes an index specifying a bandwidth part. For example, in the example shown in FIG. 8, the DCI includes an index specifying BWP #1. In response to the received DCI, the UE activates (activate) BWP #1 at a reception timing specified by the received DCI, and the UE communicates with the base station through the BWP #1.

For deactivation of (deactivate) an activated BWP, a timer is used. In the example of FIG. 8, upon expiration of a timer, the BWP #1 is deactivated, and, at a subsequent reception timing, BWP #0, which is a default bandwidth part, is activated.

As described above, according to the bandwidth part operation in NR specified in 3GPP release 15, communication by a UE that is operable in a bandwidth narrower than a maximum bandwidth specified in a system can be supported. The bandwidth part operation in this case is specified for uplink (uplink) communication and downlink (downlink) communication between a base station and user equipment.

Currently, in 3GPP, drafting of technical specifications of release 16 has been progressing. Application of a bandwidth part operation, such as that of described above, to a sidelink has been discussed, and the bandwidth part may be specified for the sidelink.

As use cases of V2X according to 3GPP release 16, various services have been studied, such as Advanced driving, Extended sensors, Vehicle platooning, Remote driving, and so forth (Non-Patent Document 3).

As types of traffic corresponding to various services, various different traffic types are assumed, such as traffic in which small-sized data is periodically transmitted, and traffic in which aperiodic large-sized data is transmitted.

Reliability required for the above-described various services, i.e., an error rate and latency, differs for each service.

Additionally, corresponding to the above-described various services, different communication types are assumed to be applied to the respective services. For example, communication types, such as unicast, which is data communication performed on a one-to-one basis by specifying a single address, multicast, which is data communication performed on a one-to-multiple basis by specifying specific addresses, broadcast, which is data communication performed on a one-to-unspecified large number basis by specifying all destinations in a same data link, etc., are assumed to be utilized.

As described above, in V2X, transmission and reception of various types of data with different requirements on communication (an error rate, latency, a communication rate, a communication type, etc.) are considered to be required. In this case, if scheduling is individually performed for various types of data and a bandwidth part operation is applied, an overhead of control signals may increase, and, additionally, a communication device that is operable in a bandwidth narrower than a maximum bandwidth defined in a system may be unable to communicate appropriately. Namely, by individually performing scheduling of various types of data, specific data may be transmitted outside a bandwidth supported by a communication device, and the communication device may be unable to receive the specific data.

As for a bandwidth part operation specified in 3GPP release 15, upon an initial-access, a UE uses a minimum bandwidth (BW) required for the initial-access. By preconfiguring so that a type of data with a high priority level can be received in the minimum bandwidth, a UE is able to receive the type of data with the high priority level. Such a scheme can be applied to D2D communication (communication via a sidelink) in which terminals communicate with each other without intervention of a base station.

Namely, for D2D communication, a plurality of radio resources (which may be referred to as a bandwidth part or a component carrier (CC)) may be configured, and a preconfiguration may be made as to which radio resource of the above-described plurality of radio resources is to be used for each requirement of a plurality of requirements on communication. Each radio resource of the above-described radio resources may be a resource block formed of a plurality of resource elements in a time and frequency domain used for transmission and reception of data.

Specifically, priority levels may be assigned to a plurality of respective radio resources in advance. If the priority levels are assigned to the plurality of respective radio resources as described above, for example, when data to be transmitted is generated, a communication device may transmit the data using a radio resource with a priority level corresponding to ProSe Per Packet Priority (PPPP) assigned to the data. For example, when Resource #0 and Resource #1 are configured as a plurality of radio resources, and a priority level A is assigned to Resource #0 and a priority level B is assigned to Resource #1, Resource #0 may be used for transmitting data with the priority level A, or Resource #1 may be used for transmitting data with the priority level B (here, for example, the priority level A may be higher than the priority level B). In the above-described example, #0 and #1 attached to Resource #0 and Resource #1 may be referred to as information indicating a plurality of radio resources.

Additionally, the priority level A assigned to Resource #0 and the priority level B assigned to Resource #1 may be referred to as information indicating a priority level of each radio resource of a plurality of radio resources. Additionally, the priority level A and the priority level B assigned to the data may be referred to as information indicating a priority level of data.

Additionally, for each resource of the above-described plurality of radio resources, the following may be configured for transmitting data: a modulation scheme, a code rate, a waveform (CP-OFDM/DFT-S-OFDM), Numerology, Rank, and/or presence of absence of application of transmission diversity.

The above-described plurality of radio resources may be preconfigured by a base station, or may be autonomously configured by a communication device. When the above-described plurality of radio resources is preconfigured by a base station, the base station may report the configured radio resources to a communication device via Physical Broadcast Channel (PBCH); via PBCH and/or Physical Sidelink Broadcast Channel (PSBCH); by Radio Resource Control (RRC) layer signaling; by Medium Access Control (MAC) layer signaling; by Downlink Control Information (DCI); by DCI and/or Sidelink Control Information (SCI); or some combination thereof.

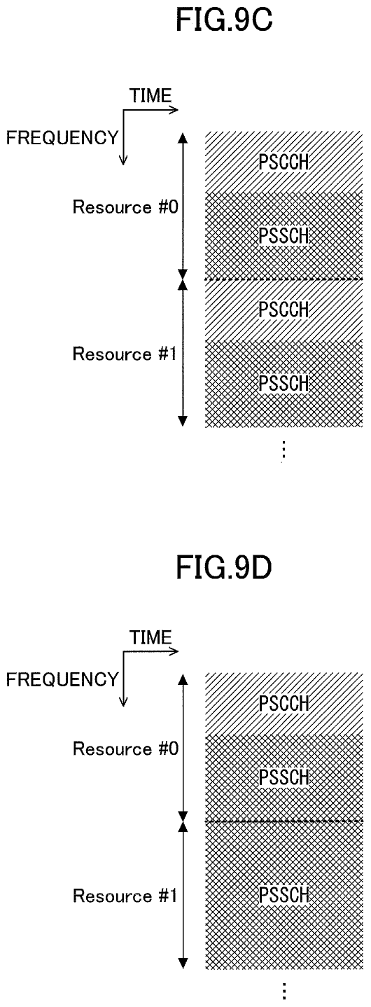

A number of the above-described plurality of radio resources may be determined by a base station based on UE capability. Alternatively, the number of the above-described plurality of radio resources may be autonomously determined by a communication device based on UE capability. For example, as illustrated in FIG. 9A through FIG. 9F, if Resource #0 and Resource #1 can be configured as a plurality of radio resources, only Resource #0 may be configured for a communication device that supports only one resource from among Resource #0 and Resource #1, and the communication device may transmit and receive data through Resource #0. Furthermore, for a communication device that supports both Resource #0 and Resource #1, Resource #0 and Resource #1 may be configured, and the communication device may transmit and receive data through Resource #0 and Resource #1. In the examples illustrated in FIG. 9A through FIG. 9F, Resource #0 may correspond to a minimum bandwidth (BW) used by a UE for an initial-access in a bandwidth part operation specified in 3GPP release 15.

In general, as a plurality of radio resources, Resource #0, Resource #1, . . . , and Resource #(N−1) can be configured (N is an integer greater than or equal to 2). In this case, for a communication device that supports only one resource, only Resource #0 may be configured, among Resource #0, Resource #1, . . . , and Resource #(N−1). For a communication device that supports all of N resources, Resource #0, Resource #1, . . . , and Resource #(N−1) may be configured.

Alternatively, the number of the above-described plurality of radio resources may be a number that is less than or equal to a number of radio resources that can be configured for a communication device based on UE capability.

Additionally, among the above-described plurality of radio resources, a number of radio resources used for data transmission may or may not be equal to a number of radio resources used for data reception.

A configuration of the above-described plurality of radio resources for D2D communication is further described. In general, as a plurality of radio resources, Resource #0, Resource #1, . . . , and Resource #(N−1) can be configured in a frequency direction (N is an integer greater than or equal to 2). However, for convenience of descriptions, as illustrated in FIG. 9A through FIG. 9F, cases are described in which Resource #0 and Resource #1 are configured in the frequency direction. Here, the value of N is not limited to 2, and N may be greater than 2.

A sidelink synchronization signal (SLSS) is transmitted at least through Resource #0. Additionally, the SLSS may be transmitted through Resource #1 (Resource #1 and after), or the SLSS may not be transmitted through Resource #1 (Resource #1 and after). If synchronization is established between Resource #0 and Resource #1 (Resource #1 and after), synchronization between communication devices may be established using an SLSS transmitted through Resource #0. Additionally, a plurality of resources among which synchronization is established may be grouped, and an SLSS may be configured for each group. In this case, in each group, an SLSS may be transmitted through at least one resource.

Physical Sidelink Control Channel (PSCCH) is included, at least, in Resource #0. Additionally, PSCCH may be included in Resource #1 (Resource #1 and after), or PSCCH may not be included in Resource #1 (Resource #1 and after). When PSCCH is not included in Resource #1 (Resource #1 and after), scheduling of Physical Sidelink Shared Channel (PSSCH) of Resource #1 (Resource #1 and after) may be performed by PSCCH of Resource #0, or may be separately performed by PBCH, PBCH and/or PSBCH, RRC layer signaling, or MAC layer signaling, etc. When PSCCH is included in Resource #1 (Resource #1 and after), PSCCH included in Resource #n may include information indicating whether PSCCH is included in Resource #n+k (k is an integer greater than or equal to 1). Alternatively or additionally, each resource other than Resource #0 may be configured to include PSCCH or not. In this case, for example, a bitmap indicating whether PSCCHs are included in respective resources other than Resource #0 may be configured, and a signal including the bitmap may be transmitted through PSCCH included in Resource #0.

In each resource including PSCCH, which is described above, PSCCH and PSSCH may be frequency-multiplexed, or time-multiplexed. Alternatively, PSCCH and PSSCH may be frequency-multiplexed and time-multiplexed.

FIG. 9A is a diagram illustrating an example in which PSCCH and PSSCH are time-multiplexed in each of Resource #0 and Resource #1. FIG. 9B is a diagram illustrating an example in which PSCCH and PSSCH are time-multiplexed in Resource #0, and only PSSCH is included in Resource #1. FIG. 9C is a diagram illustrating an example in which PSCCH and PSSCH are frequency-multiplexed in each of Resource #0 and Resource #1. FIG. 9D is a diagram illustrating an example in which PSCCH and PSSCH are frequency-multiplexed in Resource #0, and only PSSCH is included in Resource #1. FIG. 9E is a diagram illustrating an example in which PSCCH and PSSCH are frequency-multiplexed and time-multiplexed in each of Resource #0 and Resource #1. FIG. 9F is a diagram illustrating an example in which PSCCH and PSSCH are frequency-multiplexed and time-multiplexed in Resource #0, and only PSSCH is included in Resource #1.

Resource #0, Resource #1, . . . , and Resource #(N−1) arranged in the frequency direction, as the above-described radio resources, may be contiguously arranged on a frequency axis, or may be discontinuously arranged on the frequency axis.

Resource numbers (i.e., #0, #1, . . . , and #(N−1)) for specifying Resource #0, Resource #1, . . . , and Resource #(N−1), respectively, arranged in the frequency direction, as the above-described radio resources, may be attached to the respective resources in ascending order of frequencies in the frequency axis direction; may be attached to the respective resources in descending order of frequencies; or may be attached to the respective resources in an order other than the above-described order, such as a case in which virtual resource blocks are used. Here, the resource numbers attached to the above-described plurality of radio resources, respectively, may be associated with priority levels attached to the plurality of radio resources, respectively. For example, priority levels may be defined such that, as a resource number becomes smaller, a priority level of the corresponding radio resource becomes higher. Specifically, among Resource #0, Resource #1, and Resource #(N−1) corresponding to resource numbers #0, #1, #2, . . . , and #(N−1), respectively, a priority level assigned to Resource #0 may be the highest, and a radio resource with a second highest priority level may be Resource #1. However, assignment of priority levels to the plurality of radio resources is not limited to this example, and any other prioritization may be made. For example, assignment may be made such that, as a resource number becomes greater, a priority level of the corresponding radio resource becomes higher.

A communication device that receives signals through Resource #0, Resource #1, . . . , and Resource #(N−1) arranged in the frequency direction, as the above-described plurality of radio resources, may decode the signals received through the respective radio resources in ascending order of resource numbers for specifying the respective radio resources. In this case, as described above, if priority levels are assigned to the plurality of radio resources such that, as a resource number becomes smaller, a priority level of the corresponding radio resource becomes higher, a signal received through a radio resource with a small resource number, namely, a signal received through a radio resource with a high priority level is preferentially decoded. Accordingly, more important information is preferentially transmitted to a higher layer. For example, as illustrated in FIG. 9A through FIG. 9F, when Resource #0 and Resource #1 can be configured as a plurality of radio resources, an SLSS is transmitted, at least, through Resource O. Accordingly, if a receiving communication device in D2D communication is configured so that the communication device decodes signals received through respective resources in ascending order of resource numbers for specifying the respective radio resources, it follows that the communication device preferentially decodes an SLSS, and, thus, synchronization information can be preferentially transmitted to a higher layer.

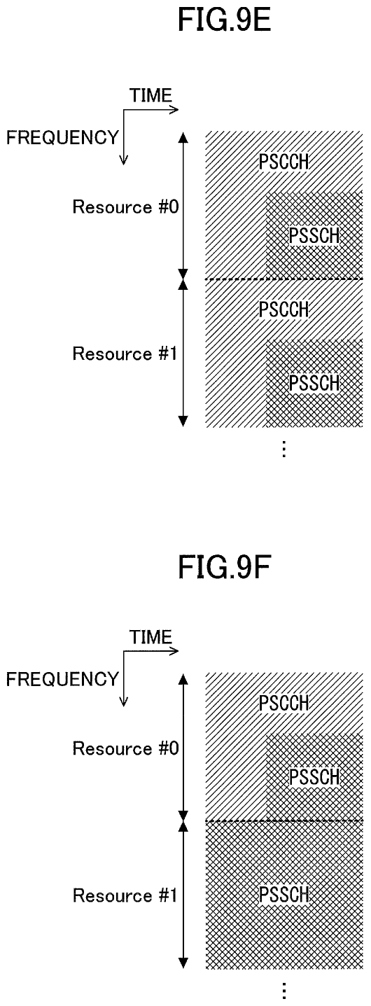

Next, an operation example in the radio communication system according to an embodiment is described by referring to FIG. 10.

First, at step S101, the base station 10 configures a plurality of radio resources available for D2D communication, and the base station 10 assigns priority levels to the respective radio resources. For example, the base station 10 configures Resource #0 and Resource #1, as the radio resources available for D2D communication. Alternatively, Resource #0 and Resource #1 may be defined, by a specification, as the radio resources available for D2D communication. Additionally, priority levels between Resource #0 and Resource #1 described above may be defined by a specification. The base station assigns a high priority level to Resource #0 and assigns a low priority level to Resource #1.

Next, at step S102, the base station 10 transmits, to the communication device 20A, a control signal including information indicating the above-described plurality of radio resources available for D2D communication and information indicating the priority levels assigned to the respective radio resources.

In response to receiving the control signal transmitted from the base station 10, at step S103, the communication device 20A transmits, to the communication device 20B through a sidelink, a control signal including information indicating the above-described plurality of radio resources available for D2D communication and information indicating the priority levels assigned to the respective radio resources. Alternatively, the communication device 20B may receive, from the base station 10, the control signal including the information indicating the above-described plurality of radio resources available for D2D communication and the information indicating the priority levels assigned to the respective radio resources.

Subsequently, when a plurality of data items to be transmitted to the communication device 20B is generated in the communication device 20A, the communication device 20A determines radio resources used for transmitting the data items in accordance with PPPP of each data item of the plurality of data items. At step S104, the communication device 20A transmits each data item to the communication device 20B using a radio resource to which a priority level corresponding to the PPPP of the data item is assigned. For example, suppose that data A and data B are generated, and that PPPP of data A indicates a high priority level and PPPP of data B indicates a low priority level. In this case, the communication device A transmits data A using Resource #0 and transmits data B using Resource #1. For example, data A may include, as data, information related to traveling of an automobile that is periodically transmitted (for example, information indicating that an automobile ahead is going to turn to the right, or information indicating that an automobile ahead applies a brake). Such information is information with high priority that is received in common by communication devices in the vicinity. Data B may include, for example, data of an image captured by an in-vehicle camera. Such information is additional information, which is information that can be optionally received by a communication device provided with a function for decoding image data.

In response to receiving data from the communication device 20A, at S105, the communication device 20B decodes data items transmitted through respective radio resources in order corresponding to priority levels assigned to the respective radio resources. For example, when a high priority level is assigned to Resource #0 and a low priority level is assigned to Resource #1, and when data A is transmitted using Resource #0 and data B is transmitted using Resource #1, first, the communication device 20B decodes data A, and, subsequently, the communication device 20B decodes data B.

As described above, information transmitted through a radio resource to which a high priority level is assigned may be information with a high priority level that is received in common by communication devices in the vicinity of the communication device 20A. Additionally, information transmitted through a radio resource to which a low priority level is assigned may be information that can be optionally received by a communication device provided with an additional function, among communication devices in the vicinity of the communication device 20A. Accordingly, depending on a function of the communication device 20B, among the above-described plurality of radio resources, only a signal transmitted using one or more radio resources with a high priority level may be decoded, and a signal transmitted using a radio resource with a low priority level may not be received, or may not be decoded even if the signal is received.

In the above-described example in which data A is transmitted through Resource #0 and data B is transmitted through Resource #1, the communication device 20B may only receive and decode data A, and the communication device 20B need not receive data B or need not decode data B.

Alternatively, when transmission power of the transmitting communication device 20A is limited, the communication device 20A may only transmit data A through Resource #0, and the communication device 20 A need not transmit data B through Resource #1. The base station 10 may indicate whether transmission is performed with a resource (or whether transmission and reception are omitted). Additionally, when a resource (or a resource group) is associated with a DL/UL BWP and the DL/UL BWP is switched, an SL resource (resource group) may be switched.

Note that, in the example illustrated in FIG. 10, the base station 10 configures the plurality of radio resources available for D2D communication and assigns the priority levels to the plurality of radio resources, and the base station 10 reports the plurality of resources and the priority levels to the communication device 20A. However, the embodiments are not limited to this example. For example, instead of reporting, by the base station 10, the plurality of radio resources and the priority levels to the communication device 20A, the communication device 20A may autonomously configure a plurality of radio resources available for D2D communication, and the communication device 20A may assign priority levels to the respective radio resources.

In FIG. 10, the example is shown in which the plurality of radio resources is configured for D2D communication, and priority levels are assigned, in advance, to the respective radio resources. However, the embodiments are not limited to this example. For example, the embodiments may be applied to uplink communication between a base station and a communication device, and/or downlink communication. Accordingly, a device that performs transmission and reception is not limited to the communication device 20A and the communication device 20B in the above-described examples, and the device may be a base station or an RSU (Roadside Unit).

(Device configuration) Next, examples of functional configurations of the base station 10 and the communication device 20 are described, which execute processing operations described above.

<Base Station 10>

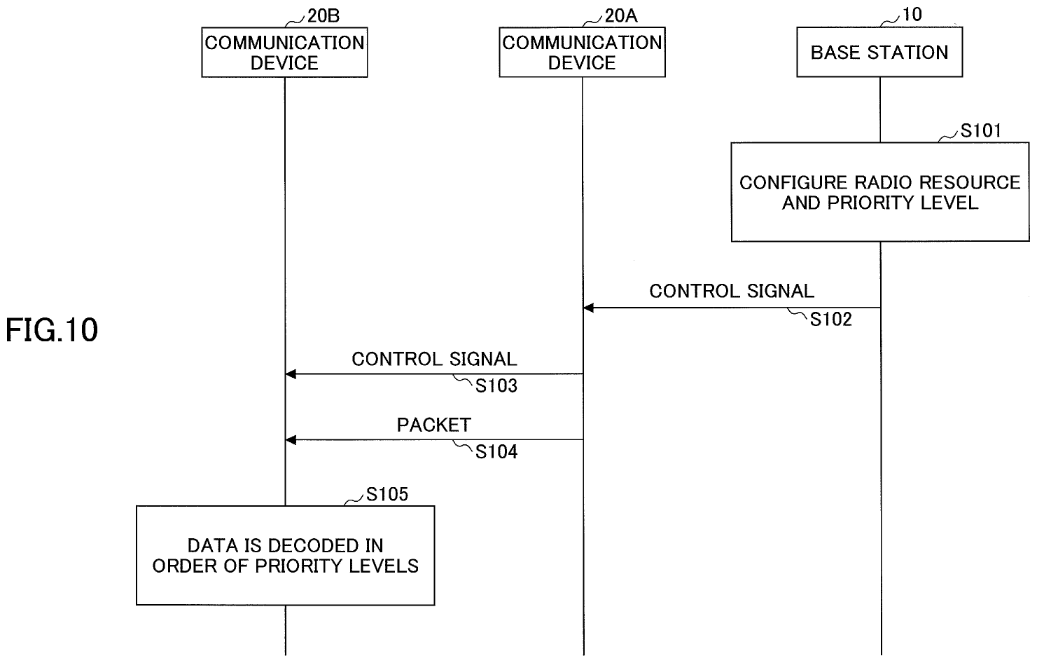

FIG. 11 is a diagram illustrating an example of the functional configuration of the base station 10. As illustrated in FIG. 11, the base station 10 includes a transmitter 101; a receiver 102; a configuration information manager 103; and a controller 104. The functional configuration illustrated in FIG. 11 is merely an example. The functional division and the name of the functional unit may be any division and any name, provided that the operation according to the embodiments can be executed. Here, the transmitter 101 may be referred to as a transmitter, and the receiver 102 may be referred to as a receiver.

The transmitter 101 is provided with a function for generating signals to be transmitted to the communication device 20, and for wirelessly transmitting the signals. The receiver 102 is provided with a function for receiving various types of signals transmitted from the communication device 20, and for retrieving, for example, higher layer information from the received signals. Additionally, the receiver 102 includes a function for measuring a signal received by the receiver 102 to obtain a quality value.

The configuration information manager 103 stores configuration information that is configured in advance and configuration information received from the communication device 20. Here, configuration information related to transmission may be stored in the transmitter 101, and configuration information related to reception may be stored in the receiver 102. The controller 104 controls the base station 10. Note that a function of the controller 104 related to transmission may be included in the transmitter 101, and a function of the controller 104 related to reception may be included in the receiver 102.

For example, corresponding to the operation described by referring to FIG. 10, the controller 104 configures a plurality of radio resources that can be used for D2D communication, and the controller 104 assigns priority levels to the plurality of radio resources. The controller 104 creates information indicating the above-described plurality of radio resources available for D2D communication and information indicating the priority levels assigned to the respective radio resources, and the transmitter 101 transmits a control signal including the created information.

<Communication Device>

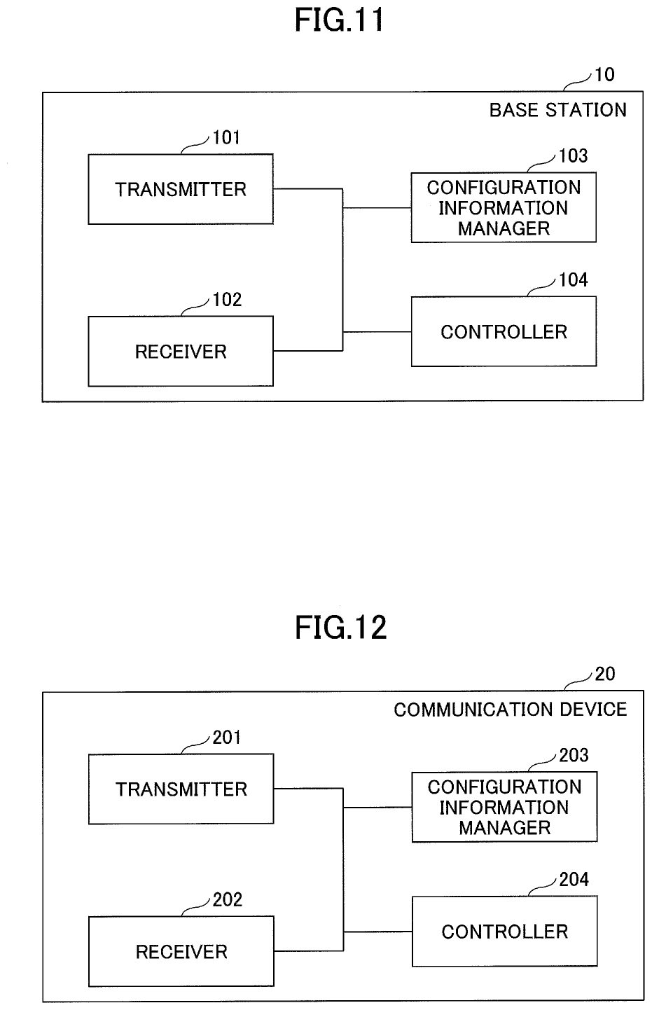

FIG. 12 is a diagram illustrating an example of a functional configuration of the communication device 20. As illustrated in FIG. 12, the communication device 20 includes a transmitter 201; a receiver 202; a configuration information manager 203; and a controller 204. The functional configuration illustrated in FIG. 12 is merely an example. The functional division and the name of the functional unit may be any division and any name, provided that the operation according to the embodiments can be executed. Here, the transmitter 201 may be referred to as a transmitter, and the receiver 202 may be referred to as a receiver. Furthermore, the communication device 20 may be the transmitting communication device 20A or the receiving communication device 20B.

The transmitter 201 creates a transmission signal from transmission data and wirelessly transmits the transmission signal. The receiver 202 wirelessly receives various types of signals and retrieves a higher layer signal from the received physical layer signal. Additionally, the receiver 202 includes a function for measuring a received signal and obtaining a quality value.

The configuration information manager 203 stores configuration information configured in advance, configuration information received from the base station 10, etc. Here, configuration information related to transmission may be stored in the transmitter 201, and configuration information related to reception may be stored in the receiver 202. The controller 204 controls the communication device 20. Note that a function of the controller 204 related to transmission may be included in the transmitter 201, and a function of the controller 204 related to reception may be included in the receiver 202.

For example, corresponding to the operation described by referring to FIG. 10, the controller 204 stores the information indicating the plurality of radio resources available for D2D communication and the information indicating the priority levels assigned to the plurality of radio resources, which are received by the receiver 202 from the base station 10 or the transmitting communication device 10, in the configuration information manager 203. Additionally, the controller 204 causes the transmitter 201 to transmit the control signal including the information indicating the plurality of radio resources available for D2D communication and the information indicating the priority levels assigned to the plurality of radio resources.

Furthermore, when a plurality of data items to be transmitted is generated in the transmitter 201, the controller 204 assigns PPPP to each data item of the plurality of data items, and the controller 204 determines a radio resource used for transmitting the data item based on the assigned PPPP and the priority levels assigned to the respective radio resources stored in the configuration information manager 203. The controller 204 causes the transmitter 201 to transmit each data item using a radio resource to which a priority level corresponding to PPPP of the data is assigned.

Furthermore, in the receiving communication device 20, in response to receiving, by the receiver 202, data from the transmitting communication device, the controller 204 causes the receiver 202 to decode data items transmitted through respective radio resources in order corresponding to priority levels assigned to the plurality of radio resources.

Furthermore, if, instead of the operation described by referring to FIG. 10, the communication device 20 autonomously configures a plurality of radio resources available for D2D communication and assigns priority levels to the plurality of radio resources, the controller 204 may configure a plurality of radio resources available for D2D communication and assign priority levels to the respective radio resources, and the controller 204 may store information indicating the plurality of radio resources available for D2D communication and information indicating the priority levels assigned to the respective radio resources in the configuration information manager 203.

<Hardware Configuration>

The functional block diagrams (FIGS. 11 and 12) used in the description of the above embodiment show blocks of functional units. These functional blocks (components) are implemented by a combination of hardware and/or software. In addition, means for implementing each functional block is not particularly limited. That is, each functional block may be implemented by one device in which a plurality of elements is physically and/or logically combined, or may be implemented by two or more devices by directly and/or indirectly connecting (e.g., through wire and/or wirelessly) the two or more devices that are physically and/or logically separated.

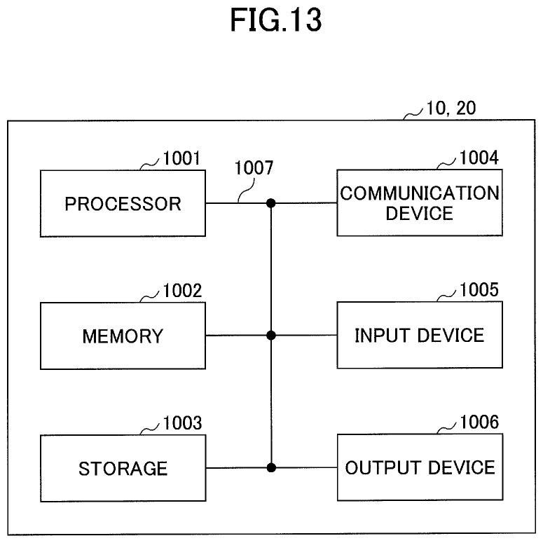

For example, the communication device 20 and the base station 10 according to the embodiment may function as computers for executing a process related to the embodiments. FIG. 13 is a diagram illustrating an example of a hardware configuration of each of the communication device 20 and the base station 10 according to the embodiments. Each of the above-described communication device 20 and the base station 10 may be physically configured as a computer device including a processor 1001, a memory 1002, a storage 1003, a communication device 1004, an input device 1005, an output device 1006, a bus 1007, etc.

Note that, in the following description, the term “apparatus” can be read as a circuit, a device, a unit, etc. The hardware configuration of each of the communication device 20 and the base station 10 may be configured to include one or more of the devices indicated by the reference numerals 1001 through 1006 shown in the figure, or may be configured not to include a part of the devices.

Each function of the communication device 20 and the base station 10 is implemented by loading predetermined software (program) on hardware, such as the processor 1001 and the memory 1002, so that the processor 1001 performs computation and controls communication by the communication device 1004, and reading and/or writing of data in the memory 1002 and the storage 1003.

The processor 1001, for example, operates an operating system to control the entire computer. The processor 1001 may be configured with a central processing unit (CPU: Central Processing Unit) including an interface with a peripheral device, a control device, a processing device, a register, etc.

Additionally, the processor 1001 reads a program (program code), a software module, or data from the storage 1003 and/or the communication device 1004 to the memory 1002, and executes various processes according to these. As the program, a program is used which causes a computer to execute at least a part of the operations described in the above-described embodiment. For example, the transmitter 101, the receiver 102, the configuration information manager 103, and the controller 104 of the base station 10 illustrated in FIG. 11 may be implemented by a control program stored in the memory 1002 and executed by the processor 1001. The transmitter 201, the receiver 202, the configuration information manager 203, the controller 204 of the communication device 20 illustrated in FIG. 12 may be implemented by a control program stored in the memory 1002 and executed by the processor 1001. Although it is described that the above-described various processes are executed by a single processor 1001, the above-described various processes may be simultaneously or sequentially executed by two or more processors 1001. The processor 1001 may be implemented by one or more chips. The program may be transmitted from a network via an electric communication line.

The memory 1002 is a computer readable recording medium, and the memory 1002 may be formed of at least one of a ROM (read-only memory), an EPROM (erasable programmable), an EEPROM

(Electrically Erasable Programmable ROM), a RAM (Random Access Memory), etc. The memory 1002 may be referred to as a register, a cache, a main memory (main storage device), etc. The memory 1002 can store executable programs (program codes), software modules, etc., that can be executed to implement the process according to the embodiment of the present invention.

The storage 1003 is a computer readable recording medium, and, for example, the storage 1003 may be formed of at least one of an optical disk such as a CD-ROM (Compact Disc ROM), a hard disk drive, a flexible disk, a magneto-optical disk (for example, a compact disk, a digital versatile disk, a Blu-ray (registered trademark) disk), a smart card, a flash memory (for example, a card, a stick, a key drive), a floppy (registered trademark) disk, a magnetic strip, etc. The storage 1003 may be referred to as an auxiliary storage device. The above-described storage medium may be, for example, a database, a server, or any other suitable medium including the memory 1002 and/or the storage 1003.

The communication device 1004 is hardware (transmission/reception device) for performing communication between computers via a wired and/or wireless network, and, for example, the communication device 1004 is also referred to as a network device, a network controller, a network card, a communication module, etc. For example, the transmitter 201 and the receiver 202 of the communication device 20 may be implemented by the communication device 1004. Furthermore, the transmitter 101 and the receiver 102 of the base station 10 may be implemented by the communication device 1004.

The input device 1005 is an input device (e.g., a keyboard, a mouse, a microphone, a switch, a button, a sensor, etc.) for receiving an input from outside. The output device 1006 is an output device (e.g., display, speaker, LED lamp, etc.) that performs output toward outside. Note that the input device 1005 and the output device 1006 may be integrated (for example, a touch panel).

Furthermore, the devices, such as the processor 1001 and the memory 1002, are connected by a bus 1007 for communicating information. The bus 1007 may be formed of a single bus, or the bus 1007 may be formed of buses that are different among the devices.

Furthermore, each of the communication device 20 and the base station 10 may be configured to include hardware, such as a microprocessor, a digital signal processor (DSP: Digital Signal Processor), an ASIC (Application Specific Integrated Circuit), a PLD (Programmable Logic Device), an FPGA (Field Programmable Gate Array), etc., and a part or all of the functional blocks may be implemented by the hardware. For example, the processor 1001 may be implemented by at least one of these hardware components.

### Conclusion of the Embodiments

In the present specification, at least, the communication devices described below are described.

A communication device includes a transmitter that transmits data; and a controller that causes, based on information indicating priority levels of respective radio resources of a plurality of radio resources and a priority level of the data, the transmitter to transmit the data using a radio resource provided with a priority level corresponding to the priority level of the data.

According to the above-described configuration, when a plurality of types of data with different requirements (an error rate, latency, and speed) on communication are transmitted and received, an overhead of control signals can be reduced, compared to a case in which scheduling is individually performed for the plurality of types of data. Furthermore, when scheduling is individually performed for various types of data, specific data may be transmitted outside a bandwidth supported by the communication device, and the communication device may be unable to receive the specific data. However, according to the above-described configuration, a type of data with a high priority level is transmitted through a radio resource with a high priority level, and, at least, the type of data with the high priority level can be prevented from being transmitted outside the bandwidth supported by the communication device.

The communication device may further include a receiver that receives a signal, and the receiver may receive a signal including the information indicating the priority levels of the respective radio resources of the plurality of radio resources.

With the above-described configuration, for example, a base station can configure a plurality of radio resources and assign priority levels to respective radio resources of the plurality of radio resources, and information indicating the plurality of radio resources and information indicating the priority levels assigned to the respective radio resources of the plurality of radio resources can be reported to the communication device by DCI. Alternatively, when there are two communication devices that perform D2D communication, for example, a transmitting communication device can autonomously configure a plurality of radio resources and assign priority levels to respective radio resources of the plurality of radio resources, and the transmitting communication device can report, to a receiving communication device, information indicating the plurality of radio resources and information indicating the priority levels assigned to the respective radio resources of the plurality of radio resources by SCI.

The controller may configure the plurality of radio resources and assign the priority levels to the respective radio resource of the configured plurality of resources.

With the above-described configuration, the communication device can autonomously configure a plurality of radio resources and assign priority levels to the radio resources, without receiving information of the radio resources and information indicating the priority levels assigned to the respective radio resources, for example, through control information, etc., transmitted from the base station. Accordingly, for example, even if the communication device is located outside the coverage of the base station in D2D communication, a communication scheme can be achieved such that a radio resource with a high priority level is assigned to a data type with a high priority level.

When a synchronization signal is to be transmitted, the controller may cause the transmitter to transmit the synchronization signal through a radio resource with a highest priority level, among the plurality of priority levels of the respective plurality of radio resources.

With the above-described configuration, even if a bandwidth supported by a receiving communication device is narrow, by configuring the radio resource with the high priority level within a bandwidth supported by the communication device, the receiving communication device can be prevented from being unable to receive the synchronization signal.

When a control signal is to be transmitted, the controller may cause the transmitter to transmit the control signal through a radio resource with a highest priority level, among the plurality of priority levels of the respective plurality of radio resources.

With the above-described configuration, even if a bandwidth supported by a receiving communication device is narrow, by configuring the radio resource with the high priority level within a bandwidth supported by the communication device, the receiving communication device can be prevented from being unable to receive the control signal.

A communication device includes a receiver that receives a signal transmitted from another communication device; and a controller that causes, upon receiving the signal through a radio resource with a highest priority level among a plurality of priority levels of a respective plurality of radio resources, the receiver to decode the received signal, and that causes, upon receiving the signal through a radio resource with a priority level lower than the highest priority level, the receiver to discard the received signal.

With the above-described configuration, when a bandwidth supported by a receiving communication device is narrow, the communication device can be caused to preferentially monitor the radio resource to which the high priority level is assigned. Accordingly, the receiving device can preferentially decode the signal received through the radio resource to which the high priority level is assigned.

### Supplemental Embodiments

The embodiments of the present invention are described above. However, the disclosed invention is not limited to the embodiments, and a person ordinarily skilled in the art will appreciated various alterations, modifications, substitutions, replacements, etc. In order to facilitate understanding of the invention, the descriptions are made using specific numerical examples. However, the numerical values are merely examples, and any suitable value may be used, unless as otherwise specified. The classification of the items in the descriptions above is not essential to the present invention, and matters described in two or more items may be combined depending on necessity, or a matter described in an item may be applied to a matter described in another item (provided that they do not contradict). The boundary of the functional unit or the processing unit in the functional block diagram does not necessarily correspond to the physical component boundary. Operations of the plurality of functional units may be implemented physically by one component, or an operation of one functional unit may be physically implemented by a plurality of components. The order of the procedures described in the embodiment may be changed, provided that there is no contradiction. For convenience of the description of the process, the base station apparatus 100 and the user equipment 200 are described using the functional block diagrams. However, these devices may be implemented by hardware, software, or a combination thereof. Each of the software that is operated by the processor of the base station apparatus 100 in accordance with the embodiments of the present invention and the software that is operated by the processor of the user equipment 200 in accordance with the embodiments of the present invention may be stored in a random access memory (RAM), a flash memory, a read-only memory (ROM), EPROM, EEPROM, a register, a hard disk (HDD), a removable disk, a CD-ROM, a database, a server, or any other appropriate storage medium.

Notification of information is not limited the aspects/embodiments described in the present specification, and may be performed by other methods. For example, notification of information may be performed via physical layer signaling (for example, Downlink Control Information (DCI) or Uplink Control Information (UCI)), higher-layer signaling (for example, RRC signaling, MAC signaling, broadcast information (Master Information Block (MIB), or System Information Block (SIB)), other signals, or by a combination thereof. Moreover, an RRC message may be referred to as the RRC signaling.

Furthermore, the RRC message may be an RRC connection setup (RRC Connection Setup) message, an RRC connection reconfiguration (RRC Connection Reconfiguration) message, or the like, for example.

Each aspect/embodiment described in this specification can be applied to long term evolution (LTE), LTE-advanced (LTE-A), SUPER 3G, IMT-Advanced, 4G, 5G, future radio access (FRA), W-CDMA (registered trademark), GSM (registered trademark), CDMA2000, ultra mobile broadband (UMB), IEEE 802.11 (Wi-Fi), IEEE 802.16 (WiMAX), IEEE 802.20, ultra-wideband (UWB), Bluetooth (registered trademark), any other systems using an appropriate system and/or next generation systems expanded on the basis of these systems.

The order of the procedures, sequences, flowcharts, etc., of each aspect/embodiment described in the specification may be changed, provided that there is no contradiction. For example, for the methods described in the specification, the elements of the various steps are presented in an exemplary order, and the methods are not limited to the specific order presented.

The specific operations that are described in the present invention to be performed by the base station 10 may be performed by their upper nodes in some cases. In a network formed of one or more network nodes including the base station 10, it is apparent that the various operations performed for communication with the communication device 20 may be performed by the base station 10 and/or a network node other than the base station 10 (e.g., MME or S-GW can be considered, however, not limited to these). In the above description, a case is exemplified in which there is one network node other than the base station 10. However, it can be a combination of other network nodes (e.g., MME and S-GW).

Each aspect/embodiment described in this specification may be used alone, may be used in combination, or may be used while being switched during the execution.

The communication device 20 may be referred to, by a person ordinarily skilled in the art, as a subscriber station, a mobile unit, a subscriber unit, a wireless unit, a remote unit, a mobile device, a wireless device, a wireless communication device, a remote device, a mobile subscriber stations, an access terminal, a mobile terminal, a wireless terminal, a remote terminal, a handset, a user agent, a mobile client, a client, or the communication device 20 may be called by some other suitable terms.

The base station 10 may be referred to, by a person ordinarily skilled in the art, as a NB (NodeB), an eNB (enhanced NodeB), a base station (Base Station), gNB, or the base station 10 may be called by some other suitable terms.

The terms “determine (determining)” and “decide (determining)” used in this specification may include various types of operations. For example, “determining” and “deciding” may include deeming that a result of calculating, computing, processing, deriving, investigating, looking up (e.g., search in a table, a database, or another data structure), or ascertaining is determined or decided. Furthermore, “determining” and “deciding” may include, for example, deeming that a result of receiving (e.g., reception of information), transmitting (e.g., transmission of information), input, output, or accessing (e.g., accessing data in memory) is determined or decided. Furthermore, “determining” and “deciding” may include deeming that a result of resolving, selecting, choosing, establishing, or comparing is determined or decided. Namely, “determining” and “deciding” may include deeming that some operation is determined or decided.

The expression “on the basis of” used in the present specification does not mean “on the basis of only” unless otherwise stated particularly. In other words, the expression “on the basis of” means both “on the basis of only” and “on the basis of at least.”

As long as “include,” “including,” and variations thereof are used in this specification or the claims, the terms are intended to be inclusive in a manner similar to the term “comprising.” Furthermore, the term “or” used in the specification or claims is intended to be not an exclusive OR.

In the entire disclosure, for example, if an article, such as a, an, and the, is added by translation, the article may include a plurality of elements, unless as indicated otherwise by the context.

The present invention is described in detail above. It is apparent to a person ordinarily skilled in the art that the present invention is not limited to the embodiments described in the specification. The present invention can be implemented as a modified and altered embodiment without departing from the gist and the scope of the present invention, which are defined by the description of the claims. Accordingly, the description of the present invention is for the purpose of illustration and does not have any restrictive meaning to the present invention.

### LIST OF REFERENCE SYMBOLS

101 transmitter
102 receiver
103 configuration information manager
104 controller
201 transmitter
202 receiver
203 configuration information manager
204 controller
1001 processor
1002 memory
1003 storage
1004 communication device
1005 input device
1006 output device

1. A communication device comprising:
a transmitter that transmits data; and
a controller that causes, based on information indicating priority levels of respective radio resources of a plurality of radio resources and a priority level of the data, the transmitter to transmit the data using a radio resource provided with a priority level corresponding to the priority level of the data.

2. The communication device according to claim 1, wherein the communication device further includes a receiver that receives a signal, and
wherein the receiver receives a signal including the information indicating the priority levels of the respective radio resources of the plurality of radio resources.

3. The communication device according to claim 1, wherein the controller configures the plurality of radio resources and assigns the priority levels to the respective radio resource of the configured plurality of resources.

4. The communication device according to claim 1, wherein, when a synchronization signal is to be transmitted, the controller causes the transmitter to transmit the synchronization signal through a radio resource with a highest priority level, among the plurality of priority levels of the respective plurality of radio resources.

5. The communication device according to claim 1, wherein, when a control signal is to be transmitted, the controller causes the transmitter to transmit the control signal through a radio resource with a highest priority level, among the plurality of priority levels of the respective plurality of radio resources.

6. A communication device comprising:
a receiver that receives a signal transmitted from another communication device; and
a controller that causes, upon receiving the signal through a radio resource with a highest priority level among a plurality of priority levels of a respective plurality of radio resources, the receiver to decode the received signal, and that causes, upon receiving the signal through a radio resource with a priority level lower than the highest priority level, the receiver to discard the received signal.
